(19) United States
(12) Patent Application Publication
(10) Pub. No.: US 2010/0322444 A1
(43) Pub. Date: Dec. 23, 2010

(54) Loudspeaker arrangement

(75) Inventor: Robin Støckert, Trondheim (NO)

Correspondence Address: ABELMAN, FRAYNE & SCHWAB, 666 THIRD AVENUE, 10TH FLOOR, NEW YORK, NY, 10017, US

(73) Assignee: Leiv Eiriksson Nyskapning AS

(21) Appl. No.: 12/802,628

(22) Filed: Jun. 9, 2010

(30) Foreign Application Priority Data
Jun. 17, 2009 (NO) 20092332

(51) Int. Cl. H04R 1/42

(52) U.S. Cl. 381/165

(57) ABSTRACT

A loudspeaker arrangement (10, 100) is operable to convert in operation an electrical drive signal to acoustic radiation. The loudspeaker arrangement (10, 100) includes a panel (20) including one or more groups of one or more apertures (60) therein, and at least one component (30) cooperating with the panel (20) to define an inner volume (80) coupled in fluidic communication with an external region (90) to the loudspeaker arrangement (10), 100) via the one or more groups of one or more apertures (60). The panel (20) has mounted thereon at least one exciter element (50) for operably causing the panel (20) to flex for generating acoustic radiation from the loudspeaker arrangement (10, 100).

### FIELD OF THE INVENTION

The present invention relates to loudspeaker arrangements for converting during use a electric drive signal to acoustic radiation, which includes a panel and at least one component cooperating with the panel to define an inner volume, where the panel has mounted thereon at least one exciter element for operably causing said panel to flex for generating acoustic radiation from said loudspeaker arrangement. Moreover, the present invention also relates to methods of manufacturing such loudspeaker arrangements.

### BACKGROUND OF THE INVENTION

Various types of acoustic transducers have been previously proposed and manufactured.

Contemporary commercial electromagnetic acoustic transducers each include a conical member flexibly mounted within a support frame, the conical member being electro-magnetically actuated in respect of the support frame when in operation; an example of measuring magnetic resonance for picture editing is described in published patent application no. US2007/0080687. In US 2002/0114483 A1 there is described a speaker with a panel where to the exciter element is fastened in order to make the panel vibrate and thus bring forth acoustic radiation from the loudspeaker. Electromagnetic actuated speakers are robust and capable of handling large amounts of drive power, for example approaching 1 kW, as well as transducing signals to frequencies as low as 20 Hz and as high as 20 kHz for electromagnetic woofers and tweeters respectively. However, a problem encountered in practice is that a conical structure supported on a flexible mount exhibits complex resonance Eigenmodes at various frequencies which causes sound colouration and reduced clarity in reproduced sounds.

Such colouration problems were appreciated many years ago and resulted in more exotic types of loudspeaker, for example electrostatic loudspeakers as described in U.S. Pat. No. 3,773,984 (Walker) from year 1973. An aim of such electrostatic speakers is not to obtain a planar structure per se, but principally to obtain a far-field axis pressure which is frequency independent, thereby providing an electrostatic loudspeaker that is acoustically transparent over a complete audio frequency range. The electrostatic speakers need to be biased with a potential in an order of hundreds of volts, even several kiloVolts in certain product examples. The quality of sound reproduction from such loudspeakers is extremely high, although it is sometimes found to be difficult to obtain adequate transducing response at low frequencies below 100 Hz whereat large diaphragm excursions are potentially required.

Use of piezo-electric elements to manufacture planar loudspeakers are also known, for example as described in granted U.S. Pat. No. 7,194,098 B2 (Azima, New Transducers Ltd.). In this patent, embodiments comprise a box-like structure including a flexible membrane onto which a piezo-electric element is asymmetrical mounted. Such a planar loudspeaker suffers a problem of sound colouration due to a complex series of resonance modes occurring in operation in a continuous planar membrane.

### SUMMARY OF THE INVENTION

The present invention seeks to provide a loudspeaker arrangement which is capable of providing an enhanced quality of sound reproduction in comparison to hitherto known types of loudspeaker.

Thus the loudspeaker arrangement in accordance with the present invention is characterized by that the panel includes one or more groups of one or more apertures, where the inner volume is connected fluidly with an external area to the speaker arrangement by the one or more groups to the one or more apertures.

The invention is of advantage in that loudspeaker is capable via its slots of providing an enhanced quality of sound reproduction.

Optionally, the loudspeaker arrangement is manufactured such that the at least one exciter element includes a piezo-electric element. Piezo-electric elements are very efficient at converting electrical energy to stress energy for straining flexible structures such as the panel of the loudspeaker arrangement. More optionally, the at least one exciter element is mounted symmetrically onto the panel.

Optionally, the loudspeaker arrangement is manufactured such that the one or more groups of one or more slots are disposed in a rectilinear manner on the panel.

Optionally, the loudspeaker arrangement is manufactured such that the one or more groups of one or more slots are disposed in a radial manner on the panel.

Optionally, the loudspeaker arrangement is manufactured such that the panel is implemented in a rectilinear, triangular or ellipsoidal manner. Other geometrical manners of construction for the panel are also feasible within the scope of the present invention.

Optionally, the loudspeaker arrangement is manufactured to be disposed in combination with other loudspeakers to provide a loudspeaker unit. Such a manner of construction for the loudspeaker unit is capable of enable extremely high quality sound reproduction whilst providing an extended frequency response encompassing, for example, the full audible range of frequencies, for example 20 Hz to 20 kHz.

Optionally, the loudspeaker arrangement is provided with one or more rear vents to provide a back reflex loudspeaker configuration. Utilization of the one or more rear vents is capable of enhancing bass response of the loudspeaker arrangement and/or increasing its acoustic efficiency for converting electrical drive signals to corresponding acoustic energy.

Optionally, the loudspeaker arrangement may be mounted in a wire system or on adjustable spacers mounted to a wall—then without an inner volume/box. The distance and angle to the back wall has the same function as a physical frame/box around the speaker. In other words, one achieves the same increased bass response as an inner volume. The spacers may optionally be fitted with one or more springs/shock absorbing units (gaskets) in order to stop the transfer of vibrations to the fastening point in the existing construction.

Optionally, the loudspeaker arrangement is implemented so that the at least one component cooperating with the panel is provided with one or more projections for scattering acoustic energy within the inner volume for reducing occurrence of standing acoustic waves therein when the arrangement is in operation. Utilization of the one or more projections is capable of reducing occurrence of standing waves within the inner volume and hence improving flatness of frequency response provided by the loudspeaker arrangement.

Further, the method according to the present invention is characterized by that the method includes:
(a) manufacturing a front panel including one or more groups of one or more apertures;
(b) mounting at least one exciter element to the front panel;
(c) assembling one or more components to the panel to define an internal volume in fluid communication via the one or more groups of one or more apertures to a region external to the loudspeaker arrangement.

The steps (a) to (c) are susceptible to being implemented in various sequences whilst still representing an implementation of the invention.

It will be appreciated that features of the invention are susceptible to being combined in any combination without departing from the scope of the invention.

### DESCRIPTION OF THE DIAGRAMS

Embodiments of the present invention will now be described, by way of example only, with reference to the following diagrams wherein:

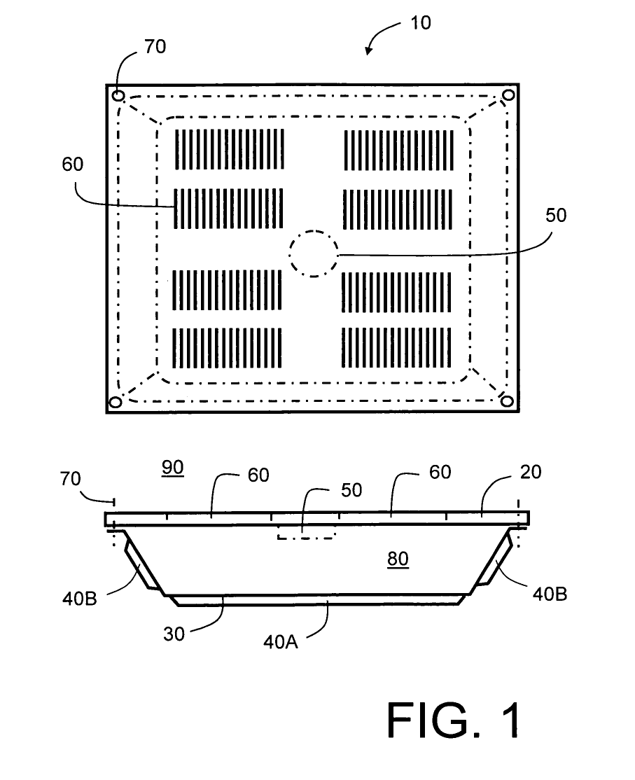

FIG. 1 is an illustration of a first embodiment of a loudspeaker arrangement pursuant to the present invention;

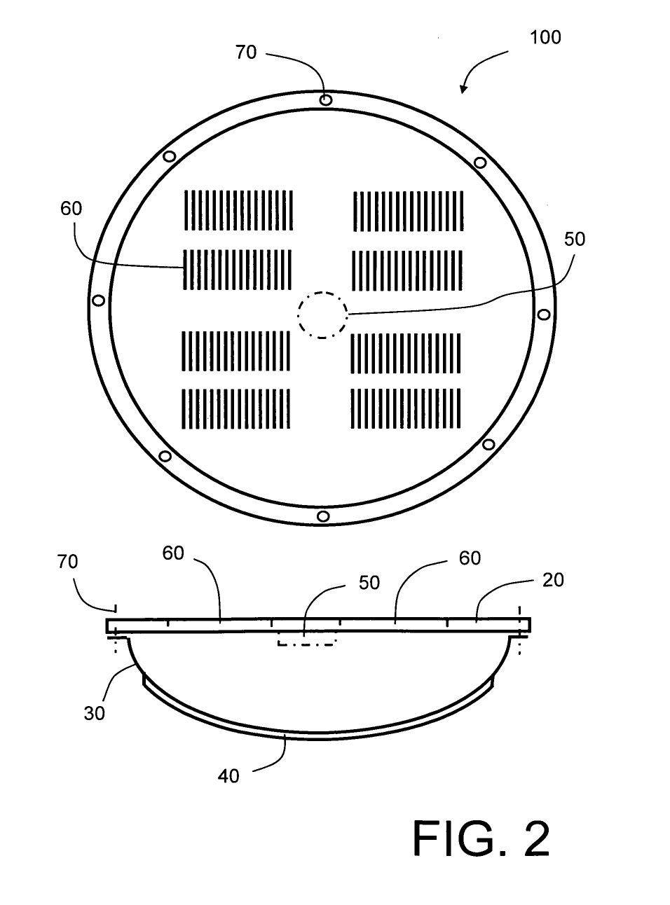

FIG. 2 is an illustration of a second embodiment of a loudspeaker arrangement pursuant to the present invention;

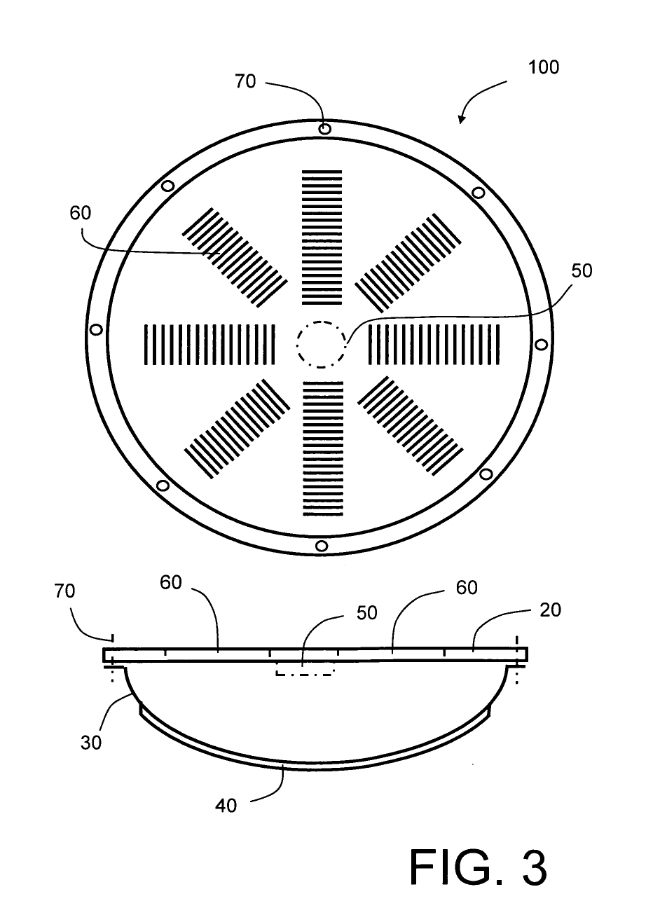

FIG. 3 is an illustration of a third embodiment of a loudspeaker arrangement pursuant to the present invention;

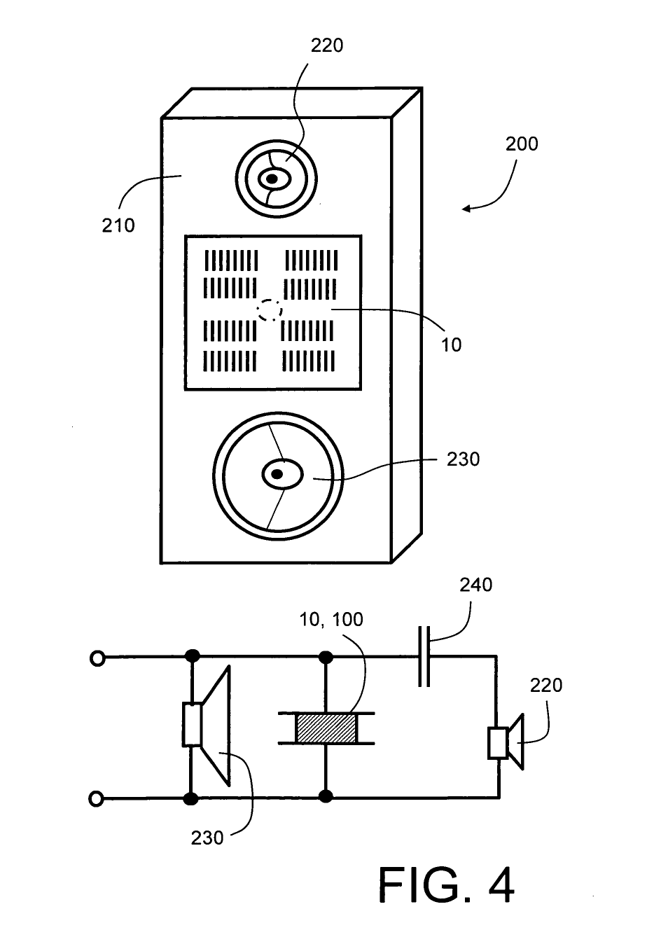

FIG. 4 is an illustration of a first configuration of loudspeakers mounted into a loudspeaker cabinet pursuant to the present invention;

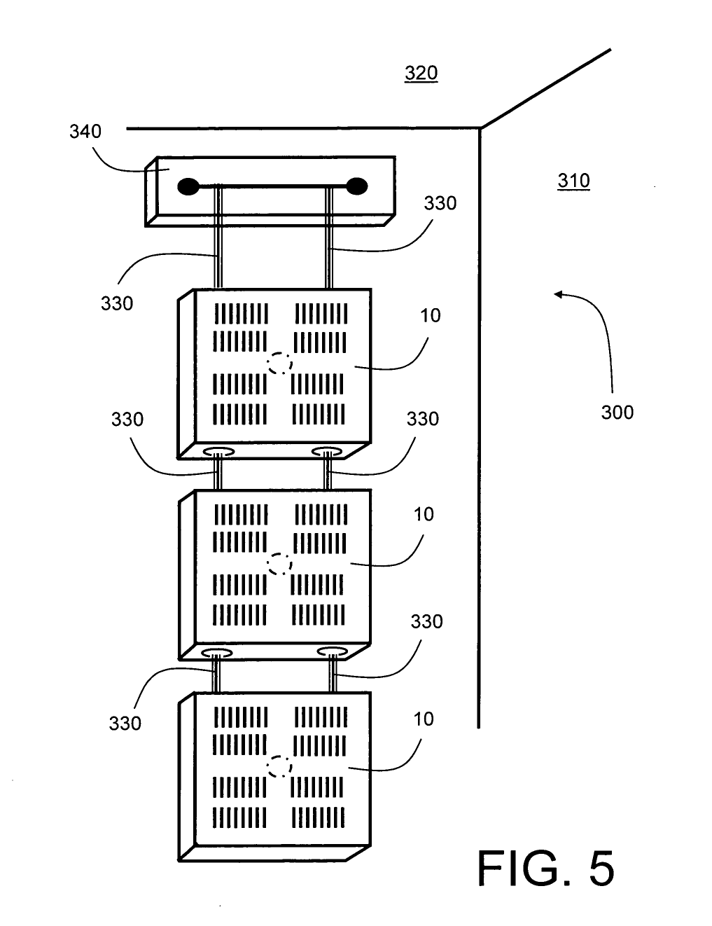

FIG. 5 is an illustration of a second configuration of loudspeakers in a hanging arrangement to provide an elongate spatially-distributed sound source;

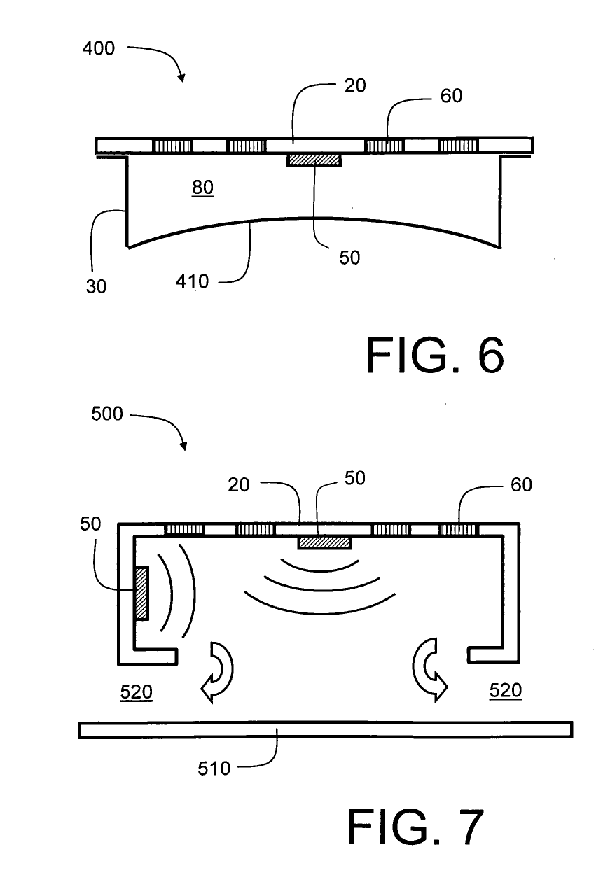

FIG. 6 is an illustration of a fourth embodiment of a loudspeaker arrangement pursuant to the present invention, the embodiment employing a concave back panel;

FIG. 7 is an illustration of fifth embodiment of a loudspeaker arrangement pursuant to the present invention including one or more rear vents in reflex configuration;

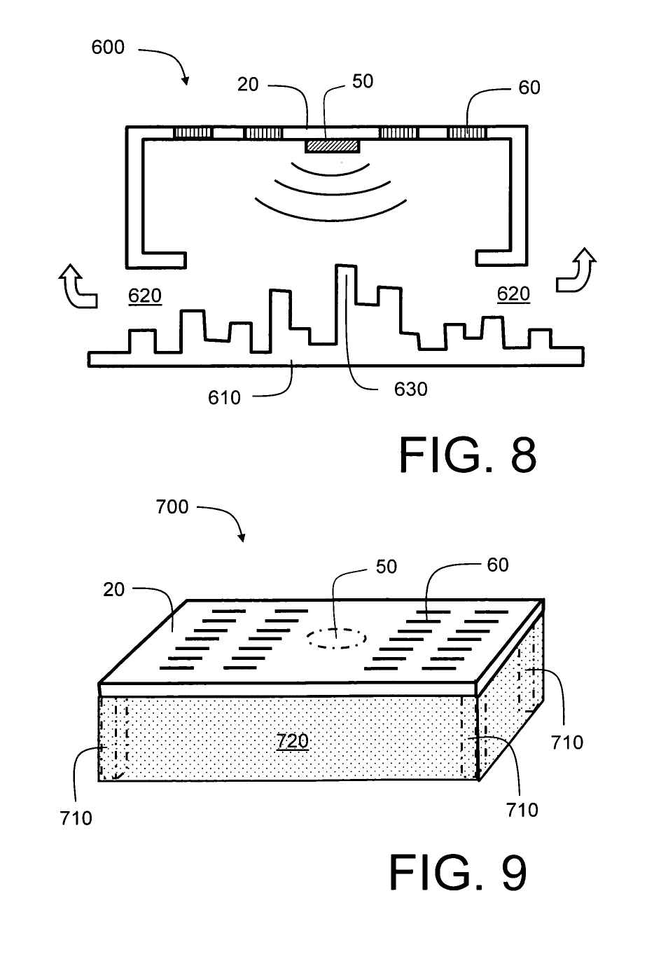

FIG. 8 is an illustration of a sixth embodiment of a loudspeaker arrangement pursuant to the present invention including one or more rear vents in reflex configuration with a profiled back panel for reducing standing resonances by way of standing waves within the loudspeaker arrangement; and

FIG. 9 is an illustration of a seventh embodiment of a loudspeaker arrangement pursuant to the present invention constructed in an open form with flexible material side panels.

In the accompanying diagrams, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DESCRIPTION OF EMBODIMENTS OF THE INVENTION

In describing the present invention, the expression “loudspeaker” is used to refer to all types of transducer capable of converting an electrical signal into corresponding acoustic pressure waves, for example which can be received by the human ear.

Referring to FIG. 1, there is shown a loudspeaker arrangement pursuant to the present invention. The loudspeaker arrangement is indicated generally by 10. The loudspeaker arrangement includes a front panel 20 coupled to a back component 30. The back component 30 is optionally stiffened with base ridges 40A and side ridges 40B for enhancing its mechanical rigidity. The ridges 40A, 40B are optionally mutually parallel, alternatively mutually diagonal and/or mutually perpendicular. The back component 30 is beneficially at least one of: cast, machined, moulded, pressed, thermally formed and explosively formed. The back component 30 is beneficially fabricated from at least one of:
(a) metal, for example aluminium or steel;
(b) plastics material, for example acrylic plastics material or filled plastics material;
(c) wood, for example beechwood;
(d) reinforced carbon fibre or reinforced fibreglass;
(e) concrete, stone or glass.

Side walls of the back component 30 are beneficially implemented in a tapered manner as illustrated. The front panel 20 is beneficially manufactured from at least one of:
(i) plastics material, for example acrylic plastics material, polypropylene, nylon, Teflon, PTFE, Perspex;
(ii) sheet metal, for example with slots punched therein; and
(iii) flexible wood, for example willow wood.

A piezo-electric exciter 50 is beneficially mounted to the panel 20 as illustrated; beneficially, the exciter 50 is centrally mounted to the panel 20 although asymmetrical mounting is also feasible. The exciter element may of course also be any exciting element, such as an electromagnetic exciter element. A configuration of one or more groups of one or more slots 60 are formed into the front panel 20, namely penetrating through a depth of the front panel 20. The slots function as apertures in the front panel 20. Each slot is capable of functioning as an individual acoustic radiation source, such that speaker arrangement 10 thereby corresponds to an array of a plurality of minute acoustic radiation emitters. Optionally, there are provided at least two groups of slots 60. Optionally, each group includes at least two slots, for example in a range of 2 to 100 slots. Each slot is about 0.05 to 3 mm wide. Each slot is beneficially in a range of 0.5 to 3 mm wide. Each slot has a length:width ration of 2:1 to 500:1. Optionally, each slot has a length:width ratio in a range 2:1 to 50:1. Optionally, the slots 60 are of mutually different length and/or mutually different width, for example tapered along a length of a group. The slots (holes) defines rays/columns, and it is advantageous for these to be long, since long slots define elongated columns between each other. the height to width ratio for the columns themselves is preferably in the area of 1:2 to 1:30. The one or more groups of one or more slots 60 are beneficially disposed symmetrically around the piezo-electric exciter 50. The slots 60 are beneficially laser cut and/or mechanically cut and/or moulded. Mechanical cutting is beneficially performed by a row of circular cutting blades mounted to a common spindle. Moreover, mechanical cutting is potentially faster in manufacture than laser cutting and also provided a benefit of utilizing less capitally-intensive apparatus. Beneficially, the one or more groups of one or more slots 60 provide a path for fluid communication from an interior region 80 of the loudspeaker 10 to an external region 90 surrounding the loudspeaker 10.

The front panel 20 is attached to the back component 30 by at least one of: screws, adhesives, friction welding, rivets, snap-connections, although other fixing methods can be employed. A peripheral region of the front panel 20 is provided with fastening points or holes 70 for use when mounting the loudspeaker arrangement 10 to cabinets, enclosures and so forth.

Alternatively, the speaker arrangement 10 is optionally implemented in circular format as illustrated in FIG. 2 as indicated by 100. The speaker arrangement 100 includes the front panel 20 implemented in ellipsoidal form, for example circular form. The one or more groups of one or more slots 60 are beneficially disposed in an arrangement as illustrated, namely in a symmetrical form of arrays of slots 60. Alternatively, the one or more groups of one or more slots 60 are disposed in a radial manner around the piezo-electric exciter 50 as illustrated in FIG. 3. Moreover, the back component 30 is beneficially implemented in a substantially hemispherical or hemi-ellipsoid form as illustrated. The advantage of the speaker arrangement 100 is that it can be manufactured to be a form-fit replacement for conventional round-format electromagnetically-actuated loudspeakers. Optionally, the back component 30 includes one or more ridges 40 for rendering the back component 40 stiffer. Optionally, the one or more ridges 40 of the speaker arrangement 100 are implemented in a radially-symmetrical manner.

The speaker arrangement 10, 100 is capable of being used in high fidelity applications because of its reduced degree of sound colouration and wide acoustic energy dispersion characteristic in comparison to conventional electromagnetically-actuated cone-diaphragm loudspeakers. The speaker arrangement 10, 100 is capable of being mounted within a cabinet or enclosure and driven by a signal from an electronic amplifier. Optionally, especially when the back component 20 is manufactured from a heat-conducting metal such as aluminium, such an amplifier is mounted to the back component 20 so that the amplifier is cooled by fluidic dissipation synergistically occurring, at least in part, through the one or more groups of one or more slots 60 to the external region 90.

Optionally, configurations of a plurality of the loudspeaker arrangements 10, 100 can be mounted into a cabinet or enclosure to provide more acoustic output. Optionally, the plurality of the loudspeaker arrangements 10, 100 are of mutually different size to provide an extended frequency response range.

Referring to FIG. 4, the speaker arrangement 10 is susceptible to being mounted in a multi-speaker arrangement as indicated by 200. The multi-speaker arrangement 200 includes a cabinet 210 into which the speaker arrangement 10 together with a tweeter 220 and an electromagnetically-actuated woofer 230 are also mounted for example. Optionally, the speaker arrangement 10 is coupled in parallel with the woofer 230 and the tweeter 220 fed via a capacitor 240 to function as a simple high-pass filter formed with a resistance of the tweeter 220; by such a parallel arrangement, optimal loudspeaker damping can be achieved and thereby superlative sound reproduction performance. Optionally, the speaker arrangement 10 is replaced by the speaker arrangement 100.

The speaker arrangement 10, 100 is beneficially disposed in plurality in vertical speaker towers in use for providing superlative acoustic clarity as well as impressive stereo image. For example, in FIG. 5 there is shown a hanging arrangement of the loudspeaker arrangements 10 suspended by flexible supports 330, for example chains, from a wall-mounted support bracket 340 mounted to one or more walls 310 of a room with ceiling 320. The hanging arrangement is indicated generally by 300 in FIG. 5.

In FIG. 2, the back component 30 is illustrated having a concave profile in a loudspeaker arrangement indicated generally by 400. Alternatively, the back component 30 has a convex profile an illustrated in FIG. 6 to obtain a wider angle of sound dispersion from the loudspeaker arrangement 400.

In FIG. 7, there is shown a back reflex configuration for the loudspeaker arrangement 10.

The back reflex configuration is indicated generally by 500 and includes one or more rear ports 520 as additional paths through which sound generated by the piezo-electric exciter 50 cooperating with the front panel 20 is able to exit. The one or more ports 520 are beneficially provided between one or more side portions and a rear panel 510. Optionally, the one or more side portions coupled to the front panel 20 are also provided with one or more piezo-electric exciters 50 for being excited by a drive signal. Optionally, one or more vents are provided in the rear panel 510.

In FIG. 8, there is shown a modified version of the back reflex configuration 500, wherein the modified version is indicated generally by 600. The modified version of the back reflex configuration employs a rear panel 610 including a plurality of up-standing projections 630 for causing complex scattering of acoustic energy received at the rear panel 610 to assist to reduce occurrence of standing acoustic waves which can result in an uneven frequency response for converting drive signals applied to the piezo-electric exciter 50 into acoustic energy radiated from the modified back reflex configuration 600. Optionally, the back reflex configuration includes one of more side vents 620 as illustrated.

In FIG. 7 and FIG. 8, use of back reflex configuration 500, 600 is beneficially capable of enhancing bass response, for example at frequencies below 80 Hz present in the drive signal applied to excite the piezo-electric exciter 50.

In FIG. 9, there is shown a simple configuration for the speaker arrangement 10; the simple arrangement is indicated by 700 and comprises the front panel 20 with its associated one or more groups of one or more slots 60 together with its piezo-electric exciter 50. The front panel 20 includes at its extremities one or more support members 710. One or more of sides of a volume behind the front panel 20 is bounded by one or more flexible fabric covers 720, for example woven fabric. The simple arrangement 700 for the loudspeaker arrangement 10 is potentially inexpensive to manufacture and of potentially low weight. The simple arrangement 700 can, for example, be attached to ceilings and walls of rooms, for example by hanging the simple arrangement 700 onto hooks or screws secured to the ceilings and/or walls.

Optionally, the piezo-electric exciter 50 is implemented in alternative manners, for example by utilizing an electromagnetic flexing module, or stacks of multiple piezoelectric elements.

Although rectilinear and ellipsoidal implementation of the front panel 20 is described in the foregoing, the front panel 20 is capable of having other geometrical forms, for example being of triangular or polygonal form.

Modifications to embodiments of the invention described in the foregoing are possible without departing from the scope of the invention as defined by the accompanying claims.

Expressions such as “including”, “comprising”, “incorporating”, “consisting of”, “have”, “is” used to describe and claim the present invention are intended to be construed in a non-exclusive manner, namely allowing for items, components or elements not explicitly described also to be present. Reference to the singular is also to be construed to relate to the plural.

Numerals included within parentheses in the accompanying claims are intended to assist understanding of the claims and should not be construed in any way to limit subject matter claimed by these claims.

1. A loudspeaker arrangement (10, 100) for converting in operation an electrical drive signal to acoustic radiation, that includes a panel (20) and at least one component (30) cooperating with the panel (20) to define an inner volume (80) wherein said panel (20) has mounted thereon at least one exciter element (50) for operably causing said panel (20) to flex for generating acoustic radiation from said loudspeaker arrangement (10, 100), characterized in that the panel (20) includes one or more groups of one or more apertures (60), where the inner volume (80) is coupled in fluidic communication with an external region (90) to the loudspeaker arrangement (10, 100) via said one or more groups of one or more apertures (60).

2. A loudspeaker arrangement (10,100) as claimed in claim 1, wherein said at least one exciter element (50) includes a piezo-electric element.

3. A loudspeaker arrangement (10,100) as claimed in claim 1, wherein said at least one exciter element (50) is an electro magnetic exciter element.

4. A loudspeaker arrangement (10, 100) as claimed in claim 2, wherein said at least one exciter element (50) is mounted symmetrically onto said panel (20).

5. A loudspeaker arrangement (10, 100) as claimed in claim 1, wherein said one or more groups of one or more slots (60) are disposed in a rectilinear manner on said panel (20).

6. A loudspeaker arrangement (10, 100) as claimed in claim 1, wherein one or more groups of one or more slots (60) are disposed in a radial manner on said panel (20).

7. A loudspeaker arrangement (10, 100) as claimed in claim 1, wherein said panel (20) is implemented in a rectilinear, triangular, ellipsoidal or polygonal manner.

8. A loudspeaker arrangement (10, 100) as claimed in claim 1 disposed in combination with other loudspeakers to provide a loudspeaker unit (200).

9. A loudspeaker arrangement (10, 500, 600) as claimed in claim 1 provided with one or more rear vents to provide a back reflex loudspeaker configuration.

10. A loudspeaker arrangement (10,600) as claimed in claim 1, wherein the at least one component (30) cooperating with the panel (20) is provided with one or more projections for scattering acoustic energy within the inner volume (80) for reducing occurrence of standing acoustic waves therein when the arrangement (10, 600) is in operation.

11. A method of manufacturing a loudspeaker arrangement (10, 100) as claimed in claim 1, said method including:
(a) manufacturing a front panel (20) including one or more groups of one or more apertures (60);
(b) mounting at least one exciter element (50) to said front panel (20);
(c) assembling one or more components (30) to said panel (20) to define an internal volume (80) in fluid communication via said one or more groups of one or more apertures (60) to a region external to said loudspeaker arrangement (10,100).
